(19) United States
(12) Patent Application Publication
(10) Pub. No.: US 2018/0130013 A1
(43) Pub. Date: May 10, 2018

(54) WEIGHT SENSING GLOVE AND SYSTEM

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/809,051

(22) Filed: Nov. 10, 2017

Related U.S. Application Data
(60) Provisional application No. 62/420,049, filed on Nov. 10, 2016.

(51) Int. Cl. G06Q 10/08; G01G 19/414; G01G 21/28

(52) U.S. Cl. CPC G06Q 10/087; G01G 21/28; G01G 19/4144

(57) ABSTRACT

In some embodiments, a system for weighing objects comprises a glove comprising an outer portion and an array of sensors, wherein the array of sensors includes a plurality of sensors, wherein each of the plurality of sensors is affixed to the outer portion, and a control circuit, wherein the control circuit is communicatively coupled to the sensors in the array of sensors, the control circuit configured to receive, from the plurality of sensors, indications of force, and determine, based on the indications of force, a weight of an object contacting the sensors.

### RELATED APPLICATION

This application claims the benefit of U.S. Provisional Application No. 62/420,049 filed on Nov. 10, 2016, which is incorporated herein by reference in its entirety.

### TECHNICAL FIELD

This invention relates generally to a system for determining weights of objects and, more particularly, to such a system that includes a device worn on a hand.

### BACKGROUND

Maintaining proper stock of items, both on the floor and in a stockroom, is critical to providing customers with the shopping experience they desire as well as ensuring that items are available for purchase. Bulk items, such as produce, present a challenge in estimating the amount of a product that is available for purchase. For example, many retailers will periodically weigh a display to determine the number of items on the display and weigh containers in the stockroom to determine the number of items in the stockroom. The retailer can use the combined weight to estimate the total number of items on hand (i.e., the number of items available for sale). While this may give a relatively accurate estimate of the number of items that the retailer has available for sale, it can only be done periodically (e.g., once a week or once a month). In the interim (i.e., the time between periodic weight determinations) it is difficult to estimate the number of items available for sale. Consequently, a need exists for a system that allows for more accurate estimates of the number of items available for sale.

### BRIEF DESCRIPTION OF THE DRAWINGS

Disclosed herein are embodiments of systems, apparatuses and methods pertaining to a system for weighing objects. This description includes drawings, wherein:

FIG. 1 depicts a system 100 including a glove 102 and a mobile device 106, according to some embodiments;

FIG. 2 is an exploded view of a plurality of sensors 206 affixed to a glove 208 and illustrating forces applied to triangular portions 204, 220 via an object 202, according to some embodiments, according to some embodiments;

FIG. 3 is a block diagram of a system 300 for determining the weights of objects, according to some embodiments;

FIG. 4 is a flow chart depicting example operations for determining the weights of objects, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to determining weights of objects. In some embodiments, a system for weighing objects comprises a glove comprising an outer portion and an array of sensors, wherein the array of sensors includes a plurality of sensors, wherein each of the plurality of sensors is affixed to the outer portion, and a control circuit, wherein the control circuit is communicatively coupled to the sensors in the array of sensors, the control circuit configured to receive, from the plurality of sensors, indications of force, and determine, based on the indications of force, a weight of an object contacting the sensors.

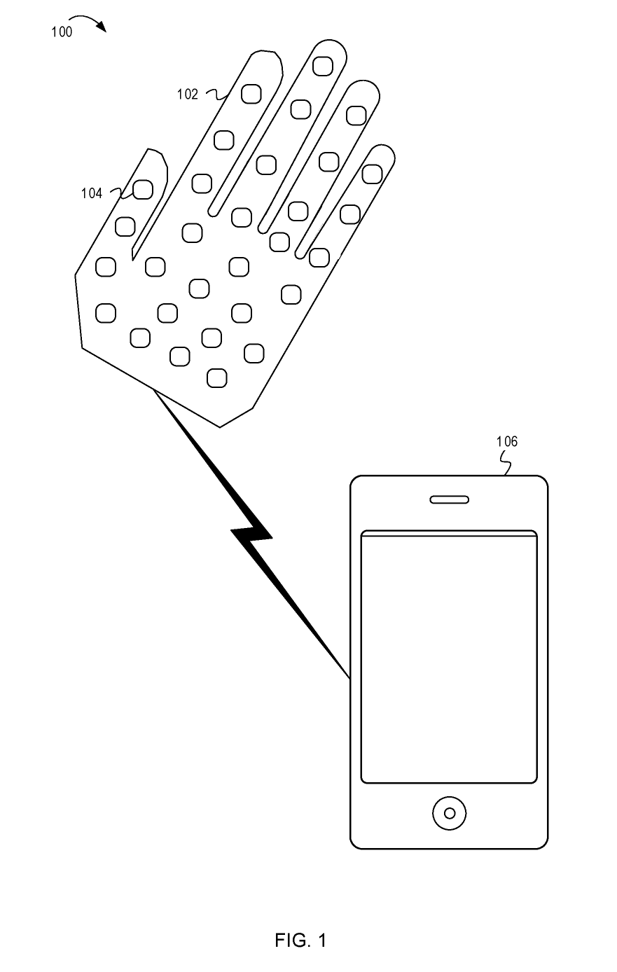

As previously discussed, many retailers estimate stock levels of bulk items by weighing all items on the sales floor (e.g., by weighing a product display) and weighing all items in the stockroom (e.g., by weighing containers holding the items in the stockroom). For example, the retailer may weigh a product display, or a portion of a product display, housing apples and all containers in the stockroom housing apples to determine the total number of apples available for sale. While this may give a relatively accurate estimate of the number of apples available for sale, it only provides an estimate at the time of weighing. Because it can be difficult and time consuming to weight the items, it is not practical to weigh the items frequently. Consequently, it is difficult to estimate the number of items available in between the weight measurements. For example, if items are weighed once a month, it can be difficult to estimate the number of items in the middle of the month. Embodiments of the inventive subject matter seek to minimize or eliminate these problems by providing a system that allows stock to be estimated whenever a product display is replenished or restocked (e.g., when stock is moved from the stockroom and loaded onto the product display). Additionally, some embodiments may aid in accurate tracking of items from stockroom to product display. The discussion of FIG. 1 provides an overview of such a system including a glove that can weigh items as they are held.

FIG. 1 depicts a system 100 including a glove 102 and a mobile device 106, according to some embodiments. The glove 102 can include and inner portion (i.e., the surface that contacts or faces toward a user's hand) and an outer portion (i.e., the surface that faces away from the user's hand). The glove 102 includes a plurality of sensors 104. The sensors 104 can be affixed to the outer portion of the glove 102. The sensors 104 can be any type of sensor that is suitable to detect weight, such as force or pressure sensors. The glove 102 is worn by a person, such as an employee, while the person handles objects (e.g., products or items offered for sale). For example, the person can wear the glove 102 while loading objects onto a product display during restocking. As the person handles an object (e.g., a single or multiple items), the sensors 104 perceive the object. If the sensors 104 are force sensors, the person applies force to the object to pick up the object, resulting in a force being applied by the glove 102 or sensors 104 to the object. This force is perceived by the sensors 104.

The sensors 104 can transmit indicia of the force to a control circuit. In the example system 100 depicted in FIG. 100, the control circuit is housed in the mobile device 106 and the sensors 104 transmit the indicia of the force to the mobile device 106. The sensors 104 can transmit the indicia of the force to the mobile device 106 via wired or wireless means. The mobile device 106 determines the weight of the object based on the indicia of the force. The determination of the weight can be an exact (or as close to exact as possible based on the resolution of the sensors 104) determination or an estimation.

In further embodiments, the mobile device 106 can determine a type of the object. For example, the mobile device 106 (more specifically, the control circuit) can determine that the object is of a category of items (e.g., produce, meat, household goods, sporting goods, etc.) or that the object is a specific item (e.g., a red delicious apple, a flank steak, a placemat, a baseball, etc.). Put simply, the type of the object can be a broad category or a specific type of object. The mobile device 106 can determine the type of the object based on the weight of the object, a location of an employee handling the item, a received indicium (e.g., via a scanned barcode or manual entry), etc. As on example, the mobile device 106 can determine that the object is an apple based on the location of the employee handling the apple and a planogram of a sales floor.

In addition to determining a type of the object, the mobile device 106 (more specifically, the control circuit) can determine a quantity of the object. For example, the mobile device 106 can determine a number of objects being loaded onto a product display. The mobile device 106 can determine the number of objects being loaded onto the product display based on the overall weight handled by the employee or the number of times the employee picks up an object (e.g., based, for example, on the indicia of force). In some embodiments, the mobile device 106 can also determine a number or quantity of the object on hand (i.e., a number of the objects available for sale). The quantity of the object on hand (e.g., the number of apples available for sale) can be the number of the object on the sales floor and the number of the object in the stockroom. The mobile device 106 can make this determination based on information received from external components (e.g., servers or other computers).

In some embodiments, the mobile device 106 (more specifically, the control circuit) can determine an action to perform. The action to perform can be based on the quantity of objects on the product display, the quantity of objects in the stockroom, the quantity of objects placed on the product display, actual or expected sales, or any combination of these quantities. The action to perform can be a restocking or stocking action, an ordering action, an investigatory action, a pricing action, or any combination of these actions. For example, if the quantity of objects available for sale is below a threshold, the mobile device 106 can determine that an ordering action to order more of the object should be performed.

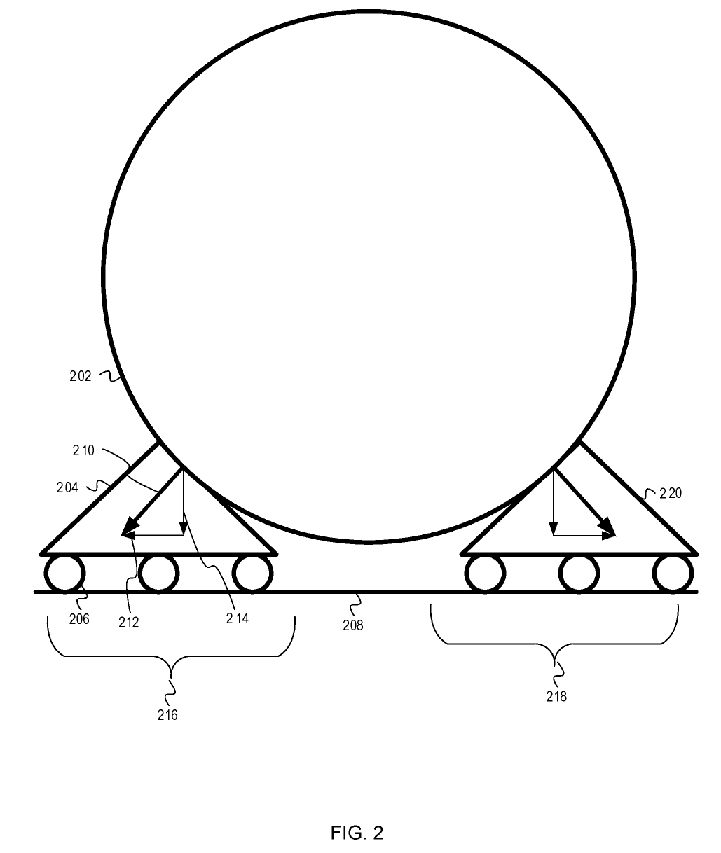

While the discussion of FIG. 1 provides background information regarding a system for determining weight of an object, the discussion of FIG. 2 provides additional description of a glove including force sensors that can be used with the system described in FIG. 1.

FIG. 2 is an exploded view of a plurality of sensors 206 affixed to a glove 208 and illustrating forces applied to triangular portions 204, 220 via an object 202, according to some embodiments. Specifically, FIG. 2 depicts and outer surface of the glove 208 to which the plurality of sensors 206 are affixed. The sensors 206 are arranged into two groups: a first group 216 and a second group 218. In the embodiment depicted in FIG. 2, a triangular portion is affixed to each group 216, 218 of sensors 206. Specifically, a first triangular portion 204 is affixed to the first group 216 of sensors 206 and a second triangular portion 220 is affixed to the second group 218 of sensors 206. When a person wearing the glove 208 picks up the object 202, forces are exerted due to the interactions between the first triangular portion 204, the second triangular portion 220, and the object 202. These forces are realized and perceived by the sensors 206.

The magnitude and direction of the forces depend upon characteristics of the object 202. For example, the magnitude and direction of the forces can depend upon the shape, weight, type, and material of the object 202, as well as an orientation of the glove 208 (e.g., whether the glove 208 is above or below the object 202). The force between the object 202 and the first triangular portion 204 can be depicted as a primary vector 210. The primary vector 210 has two components vectors, a first component vector 212 in the horizontal direction and a second component vector 214 in the vertical direction. These component vectors are indicative of the characteristics of the object 202. For example, if the object is large relative to the glove 208 and the glove is beneath the object 202 (i.e., the person is holding the object 202 in the palm of his or her and his or her palm is facing away from the ground), the second component vector 214 may be larger and the first component vector 212 smaller than if the object 202 is relatively small and held in the same orientation. In this example, the sensors 206 located away from the object 202 (i.e., the leftmost sensor 206 in the first group 216 and the rightmost sensor 206 in the second group 218) may realize a greater force when the person is holding the relatively small object as opposed to the relatively large object. In some embodiments, a type of the object 202 can be determined based on the forces realized by the sensors 206. Further, in addition to determining the orientation of the glove based on the forces, in some embodiments the glove 208 can include a positioning device (e.g., a gyroscope or accelerometer) which indicates the orientation of the glove.

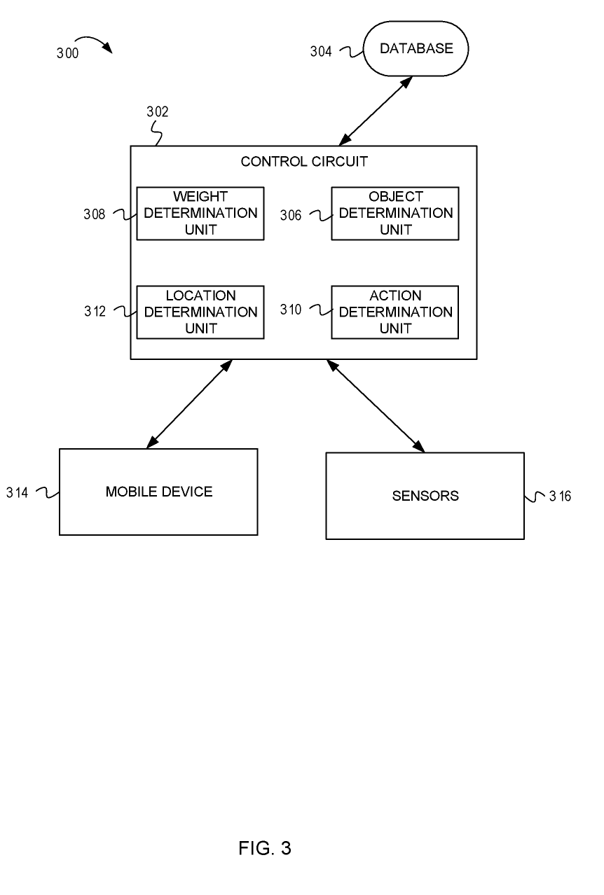

While the discussion of FIG. 2 provides additional detail regarding forces between the glove and an object when the object is being held, the discussion of FIG. 3 describes a system for weighing objects that utilizes a glove including sensors.

FIG. 3 is a block diagram of a system 300 for determining the weights of objects, according to some embodiments. The system 300 includes a control circuit 302, a mobile device 314, sensors 316, and a database 304. The control circuit 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein.

By one optional approach the control circuit 302 operably couples to a memory. The memory may be integral to the control circuit 302 or can be physically discrete (in whole or in part) from the control circuit 302 as desired. This memory can also be local with respect to the control circuit 302 (where, for example, both share a common circuit board, chassis, power supply, and/or housing) or can be partially or wholly remote with respect to the control circuit 302 (where, for example, the memory is physically located in another facility, metropolitan area, or even country as compared to the control circuit 302).

This memory can serve, for example, to non-transitorily store the computer instructions that, when executed by the control circuit 302, cause the control circuit 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 302 receives information from, and in some embodiments transmits information to, the mobile device 314, the sensors 316, and the database 304. As previously discussed, the sensors 316 are affixed to a glove and communicatively coupled to the control circuit 302. The mobile device 314 can be any suitable device (e.g., a cellular phone or tablet computer, or a device designed specifically for use with the system 300) and in some embodiments, includes the control circuit 302. Additionally, if the mobile device 314 is in proximity to the sensors 316, the mobile device 314 can provide electrical power to the sensors 316 as well as any other components associated with the glove. The database 304 can store information regarding forces and characteristics of objects. For example, the database 304 can store average weights of objects, weight ranges for objects, sizes for objects, expected forces for various objects, expected forces based on orientation of the glove, etc. Although FIG. 3 depicts the database 304 as being a standalone component, in some embodiments, the database 304 can reside within a memory local or remote from the control circuit 302, on the mobile device 314, or on a remote device (e.g., a server).

As previously discussed, the control circuit 302 receives force information (e.g., force signals or indications of force) from the sensors 316. The control circuit 302 can determine a weight of an object based on this force information. For example, the control circuit 302 can include a weight determination unit 308 which determines the weight of the object. After determining the weight of the object, the control circuit 302 can determine a type of the object. As depicted in the example system 300, the control circuit includes an object determination unit 306 which determines the type of the object. The object determination unit 306 can determine the type of the object based on the force information and/or the weight of the object as determined by the weight determination unit. For example, the object determination unit 306 can use the force information to determine a shape and/or size of the object and the weight of the object to determine the type of object. In some embodiments, the object determination unit 306 determines the type of the object by referencing the database 304. Further, the object determination unit 306 can utilize information from a location determination unit 312 to determine the type of the object. For example, the location determination unit 312 can determine a location of the glove, and thus the object. The location of the object can help determine the type of the object via, for example, a planogram by aiding disambiguation based on location. The location determination unit 312 can determine the location based on any suitable location technology such as GPS, triangulation based on Wi-Fi or WWAN, etc. In some embodiments, after determining a type of the object, the control circuit 302 can determine an action to perform. Specifically, the action determination unit 310 can determine an action to perform. The action to perform can be based on a quantity of objects of the type of object available for sale. For example, if the control circuit 302 (or any other device) determines that a product display has an insufficient stock of grapefruits based on the quantity of grapefruits in the stockroom and/or on the product display, the action determination unit 310 can determine that a restocking action should be performed.

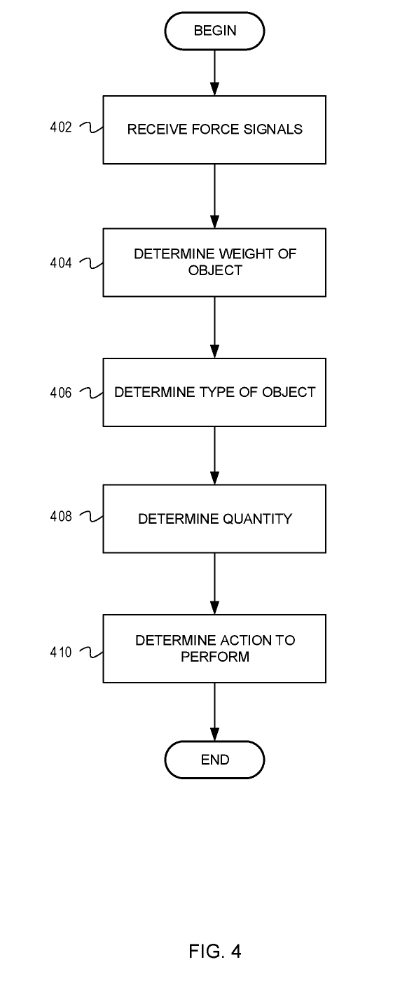

While the discussion of FIG. 3 describes a system for weighing objects that utilizes a glove including sensors, the discussion of FIG. 4 describes example operations for determining weighs of objects and actions to perform.

FIG. 4 is a flow chart depicting example operations for determining the weights of objects, according to some embodiments. The flow begins at block 402.

At block 402, force signals are received. For example, a control circuit can receive the force signals. The force signals are received from force sensors affixed to a glove. The force sensors perceive forces associated with holding an object with the glove. The control circuit can be located either locally (e.g., housed in a mobile device carried by the person wearing the glove) or remotely (e.g., housed in a computer in a backroom or stockroom) from the glove. Further, the control circuit can receive the force signals via wired or wireless means. The flow continues at block 404.

At block 404, a weight of the object is determined. For example, the control circuit can determine the weight of the object. The control circuit determines the weight of the object based on the force signals. In some embodiments, the control circuit determines the weight of the object based on magnitudes of the force signals. Additionally, or alternatively, the control circuit can determine the weight of the object based on patterns of the force signals (i.e., the relative locations of force sensors on the glove which perceive a force). The flow continues at block 406.

At block 406, a type of the object is determined. For example, the control circuit can determine the type of the object. The control circuit can determine the type of the object based on the weight of the object, the shape of the object, or the dimensions of the object, location of the object, or any combination of these characteristics. In some embodiments, the control circuit references a database to determine the type of the object. For example, the control circuit can reference a database using the weight of the object and shape of the object to determine the type of the object. The type of the object can be a specific identity (e.g., a pear or a head of lettuce) or a category of object (e.g., fruits, vegetables, etc.). The flow continues at block 408.

At block 408, a quantity of objects of the type of object is determined. For example, the control circuit can determine the quantity. The quantity of objects can be the number of all objects of the type on the sales floor, in the stockroom, in transit to the facility, on order, or any combination of these quantities. As one example, the quantity of objects of the type can include the number of avocados on the sales floor, the number of avocados in the stockroom, and the number of avocados expected to be delivered in the next two days. The flow continues at block 410.

At block 410, an action to perform is determined. For example, the control circuit can determine an action to perform. The action to perform can be based on the quantity of objects on the product display, the quantity of objects in the stockroom, the quantity of objects placed on the product display, actual or expected sales, etc. The action to perform can be a restocking or stocking action, an ordering action, an investigatory action, a pricing action, or any combination of these actions.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

In some embodiments, a system for weighing objects comprises a glove comprising an outer portion and an array of sensors, wherein the array of sensors includes a plurality of sensors, wherein each of the plurality of sensors is affixed to the outer portion, and a control circuit, wherein the control circuit is communicatively coupled to the sensors in the array of sensors, the control circuit configured to receive, from the plurality of sensors, indications of force, and determine, based on the indications of force, a weight of an object contacting the sensors.

In some embodiments, an apparatus and a corresponding method performed by the apparatus, comprises receiving, from an array of sensors affixed to an outer portion of a glove, force signals, determining, based on the force signals, a weight of an object, determining a type of the object, determining a quantity of objects of the type of object on hand, and determining, based on the quantity of objects of the type of object, an action to perform.

In some embodiments, a system for determining the weight of objects comprises a glove shaped to fit a human hand, the glove comprising an outer surface facing away from the human hand and an array of sensors, wherein the array of sensors includes two or more sensors, wherein each of the two or more sensors is affixed to the outer portion, and wherein each of the two or more sensors includes a triangular portion, and a mobile device, wherein the mobile device is communicatively coupled to the two or more sensors, the mobile device comprising a control circuit, the control circuit configured to receive, from the two or more sensors, force signals, determine, based on the force signals, a weight of an object, determine a quantity of objects of the type of object available for sale, and determine, based on the quantity of objects of the type of object, an action to perform.

What is claimed is:

1. A system for determining an action to perform based on a quantity of items in a retail facility, the system comprising:
a glove shaped to fit a human hand, the glove comprising:
an outer surface facing away from the human hand; and
an array of sensors, wherein the array of sensors includes two or more sensors, wherein each of the two or more sensors is affixed to the outer portion, and wherein each of the two or more sensors includes a triangular portion; and
a control circuit communicatively coupled to the two or more sensors, the control circuit configured to:
receive, from the two or more sensors, force signals;
determine, based on the force signals, a weight of an object;
determine a type of the object;
determine a quantity of objects of the type of object available for sale; and
determine, based on the quantity of objects of the type of the object, an action to perform.

2. The system of claim 1, wherein the action to perform is one or more of a restocking action, an ordering action, an investigatory action, and a pricing action.

3. The system of claim 1, wherein the quantity of objects of the type of object available for sale includes a first quantity and a second quantity, wherein the first quantity is a number on a sales floor and the second quantity is a number in a stockroom.

4. The system of claim 1, wherein the control circuit determines the type of the object based on one or more of a location of an employee, an indication of an item, the weight of the object, a planogram, and a shape of the object.

5. The system of claim 1, further comprising:
a mobile device, wherein the control circuit is located within the mobile device.

6. The system of claim 5, wherein the mobile device provides electrical power to the array of sensors.

7. The system of claim 1, wherein the type of the object is a category of items.

8. The system of claim 1, the glove further comprising:
a positioning device, wherein the control circuit is further configured to determine an orientation of the glove based on information received from the positioning device.

9. The system of claim 8, wherein the positioning device is a gyroscope.

10. A method for determining an action to perform based on a quantity of items in a retail facility, the method comprising:
receiving, from an array of sensors affixed to an outer portion of a glove, force signals, wherein the array of sensors includes groups of sensors, and wherein each of the groups of sensors includes a triangular portion;
determining, based on the force signals, a weight of an object;
determining a type of the object;
determining a quantity of objects of the type of object on hand; and
determining, based on the quantity of objects of the type of object on hand, an action to perform.

11. The method of claim 10, wherein the force signals are received by a mobile device.

12. The method of claim 10, further comprising:
providing, to the glove, electrical power.

13. The method of claim 10, wherein the determining the type of the object is based on one or more of a location of an employee, an indication of an item, the weight of the object, a planogram, and a shape of the object.

14. The method of claim 10, wherein the action is one or more of a restocking action, an ordering action, an investigatory action, and a pricing action.

15. The method of claim 10, further comprising:
receiving, from the glove, positioning data; and
determining, based on the positioning data, an orientation of the glove.

16. The method of claim 15, wherein the positioning data is received from a gyroscope associated with glove.

17. (canceled)

18. The method of claim 10, wherein the quantity of objects of the type of object on hand includes a first quantity and a second quantity, wherein the first quantity is a number on a sales floor and the second quantity is a number in a stockroom.

19. The method of claim 10, wherein the type of the object is a category of items.
